(19) United States
(12) Patent Application Publication
(10) Pub. No.: US 2009/0201135 A1
(43) Pub. Date: Aug. 13, 2009

(54) WIRELESS IC COMMUNICATION DEVICE AND RESPONSE METHOD FOR THE SAME

(75) Inventors: Hiromi Kawamura, Hiroshima (JP); Tadakatsu Masaki, Okinawa (JP)

Correspondence Address: WENDEROTH, LIND & PONACK L.L.P., 1030 15th Street, N.W., Suite 400 East, Washington, DC, 20005-1503, US

(73) Assignee: Panasonic Corporation, Osaka (JP)

(21) Appl. No.: 10/586,256

(22) PCT Filed: May 18, 2005
(86) PCT No.: PCT/JP05/09496

§ 371 Date: Jul. 17, 2006

(30) Foreign Application Priority Data
May 25, 2004 (JP) 2004-154142

(51) Int. Cl. H04Q 5/22

(52) U.S. Cl. 340/10.2

(57) ABSTRACT

The present invention aims to provide a wireless IC communication device that can prevent information from being read out without permission of an owner of items to each of which the wireless IC communication device is attached. The wireless IC communication device includes: a slot number obtainment unit (502) that obtains the number of time slots; a response slot information storage unit (504) that stores response slot information indicating a condition for sending an initial response to the reader/writer in the same time slot as the time slot in which at least one of other wireless IC communication devices sends an initial response; a response slot determination unit (501) that determines the time slot in which the initial response should be sent to the reader/writer; and a response unit (503) that sends the initial response to the reader/writer.

### TECHNICAL FIELD

The present invention relates to a wireless IC communication device that communicates with a reader/writer based on a time slot method or a slot marker method.

### BACKGROUND ART

Today, substantive tests and implementation of wireless IC communication device are in practice in various fields such as stock management of products, traceability of fresh food, burglar alarm for displayed products, recycle of home electric appliances, and commuter tickets and coupon tickets used for transportation. The wireless IC communication device used for stock management and traceability is called “wireless IC tag” or “Radio Frequency IDentification (RFID) tag” whereas the wireless IC communication device used for commuter tickets or coupon tickets is called “contactless IC card”.

FIG. 1A shows how to use general wireless IC tags. In general, wireless IC tags 102 to 107 are attached, one by one, to goods 108 to 113, and each of the tags grouped in a package is identified by a reader/writer 100 at the time of transportation. That is to say, the reader/writer 100 identifies plural wireless IC tags 102 to 104, and 105 to 107, and reads the information (e.g. unique ID) stored in each wireless IC tag. In this way, it is possible to know type and quantity of the goods to be transported.

FIG. 1B shows another way to use general wireless IC tags. The case here assumes a system under which diagnosis is made at a distant place and the medical fees are paid with electronic money. In the system, a contactless IC card 120 attached with a wireless IC tag 121 for verifying a qualification such as a medical license, and a contactless IC card 122 attached with a wireless IC tag 123 used for electronic money are brought above the reader/writer 100. The reader/writer 100 needs to identify plural contactless IC cards in this case as well.

As described above, in some cases, a reader/writer has to identify plural wireless IC communication devices. In such case, a time slot method is applied for the communication between each of the wireless IC communication devices and the reader/writer.

In other words, in the case where plural wireless IC communication devices operate at the same time within a communication area of the reader/writer, each of the wireless IC communication devices simultaneously sends a response signal as a response to polling performed by the reader/writer. In this case, it is impossible for any of the wireless IC communication devices to communicate with the reader/writer due to a collision between the response signals. Anti-collision function is a function to avoid such collision during the communication.

FIG. 2 is a timing chart showing a general anti-collision function. After the reader/writer 100 sends a first request command R1, the wireless IC tags 102 to 104 respectively obtains “number of slots” (the number of slots specified by the reader/writer 100) which is included in the request command R1. The “number of slots” here denotes the number of slots within which an initial response can be sent from each of the wireless IC tags 102 to 104 to the reader/writer 100. The number of slots is assumed to be “4” in this case. Note that a value necessary for deriving the number of slots, instead of the number of slots, may be included in a request command.

After that, each of the wireless IC tags 102 to 104 sends an initial response within four slots. The wireless IC tag 102 sends an initial response A21 in Slot1 while the wireless IC tags 103 and 104 respectively send initial responses A31 and A41 in Slot2. The reader/writer 100 then detects a collision of the initial responses and sends a second request command R2. As a response to this, each of the wireless IC tags 102 to 104 change a slot to send an initial response. The wireless IC tag 103 sends an initial response A32 in Slot3 while the wireless IC tag 104 sends an initial response A42 in Slot4. Thus, the reader/writer 100 detects no collisions between the initial responses, and can identify all the wireless IC tags 102 to 104.

FIG. 3 is a flowchart showing an operation performed by a general wireless IC communication device for sending an initial response. The following describes the operation with reference to FIG. 3.

Being located within a communication area in which the reader/writer operates, the wireless IC communication device is provided with power due to induced electromotive force, and waits until a request command is sent (N in Step S301).

Having received a request command (Yes in Step S301), the wireless IC communication device obtains the number of slots which is included in the request command (Step S302), and generates a random number (Step S303). The wireless IC communication device then determines a response slot based on the number of slots and the random number (Step S304). For example, in the case where the number of slots is “4” and the random number is “6”, the random number “6” is divided by the number of slots “4”, and the resulting remainder “2” is determined as a response slot number.

After the response slot is thus determined, the wireless IC communication device waits for the slot whose number indicates the response slot number. In this case, it is determined that an initial response should be sent in Slot2, so that no initial response is sent in Slot1 (N in Step S305). Then, after an initial response is sent in Slot2 (i.e. in a transitional state from Y in Step S305 to S306), the processing of sending an initial response is completed.

Note that the time taken for the wireless IC communication device to send an initial response in Slot1 after receiving a request command, and the time given for one slot are both specified in ISO/IEC14443. A method similar to such time slot method is called “slot marker method”. According to the slot marker method, the reader/writer sends, after having sent a request command, in the timing when each slot starts, a slot marker command indicating a start of slot. Despite such difference, the time slot method and the slot marker method are basically the same.

FIG. 4 shows a hardware configuration of the general wireless IC tag 102. The wireless IC tag 102 includes an antenna coil 301, a ROM 302 and a control unit 303. The antenna coil 301 receives power from an external device, and communicates with the external device. The ROM 302 stores a program. The control unit 303 performs processing according to the program stored in the ROM 302.

FIG. 5 shows a hardware configuration of a general contactless IC card 120. The contactless IC card 120 has the antenna coil 301, the ROM 302, a RAM 401, a CPU 402 and a non-volatile memory 403. The antenna coil 301 and the ROM 302 are as same as those included in the wireless IC tag 102. The RAM 401 temporally stores data to be used for executing a program. The CPU 402 performs control such as processing of various commands according to the program stored in the ROM 302. The non-volatile memory 403 can be a rewritable Electrically Erasable Programmable Read Only Memory (EEPROM) that stores the program downloaded from an external source.

The contactless IC card 120 can thus store the program downloaded from an external source. This is a notable difference between the wireless IC tag 102 and the contactless IC card 120. In other words, it is possible to have, in the contactless IC card 120, a different function depending on the usage, since the contactless IC card 120 can download a desired program.

The wireless IC communication device, in general, can be usually attached to various things, and used in a system such as stock management and burglar alarm. In this case, plural wireless IC communication devices need to be identified simultaneously or sequentially, it is therefore necessary to install an anti-collision function in each of the wireless IC communication devices.

However, the problem is that anyone can read, whenever he/she desires, the information in a wireless IC communication device that is equipped with an anti-collision function, using a reader/writer that operates in compliance with the wireless IC communication device. As a result, the information that identifies an owner of an item to which the wireless IC communication device is attached (hereinafter to be simply referred to as “owner”), such as information about a purchased item and usage history of the purchased item, is under the risk of being read out without the owner's permission. This is a serious problem known as “privacy infringement”.

A method of shortening a communication distance is conceivable as a solution to the problem. That is to say, unless the wireless IC communication device is close enough to the reader/writer, one cannot read the information in the wireless IC communication device. With this solution, it is possible to reduce the risk that the information in the wireless IC communication device is read out without the owner's permission.

In the case of applying this solution, however, it may possibly increase time in an operation that requires reading of information from many wireless IC communication devices (e.g. goods inspection). It is therefore hard for the side of those who provide wireless IC communication devices to decide whether to prioritize the needs of consumers' or those of manufacturers'.

### DISCLOSURE OF INVENTION

As described above, under the use of the conventional wireless IC communication device, any one may read out whenever he/she desires, the information in the wireless IC communication device, using the reader/writer. This causes the problem that the information in the wireless IC communication device runs the risk of being read out without the owner's permission, which leads to the infringement of his/her privacy.

The present invention is conceived in view of the above problem, and an object of the present invention is to provide a wireless IC communication device that can prevent the information from being read without the owner's permission.

In order to achieve the above object, the wireless IC communication device of the present invention is a wireless integrated circuit (IC) communication device which communicates with a reader/writer, using a time slot method or a slot marker method, and includes: a slot number obtainment unit that obtains a number of time slots which is included in a request command transmitted from the reader/writer; a response slot information storage unit that stores a response slot information indicating a condition for sending a response to the reader/writer in the same time slot as a time slot in which at least one of other wireless IC communication devices sends a response; a response slot determination unit that determines a time slot in which the response should be sent to the reader/writer, based on the number of time slots and the response slot information; and a response unit that sends the response to the reader/writer in the determined time slot. Thus, the collision of the responses is detected, without fail, at the reader/writer's side, so that it is possible to prevent the information in the wireless IC communication device from being read by the reader/writer.

To be more precise, the response slot information indicates that responses should be sent in all of the time slots, and the response slot determination unit determines that responses should be sent in all of the time slots specified by the number of time slots. Thus, the collision of the responses is detected, without fail, at the reader/writer's side, even in the case where one of other wireless IC communication devices that communicate with the reader/writer sends a response in any time slot.

The response slot information may indicate that responses should be sent in part of the time slots. In such case, the response slot determination unit determines that responses should be sent into part of the time slots specified by the number of time slots. Thus, the collision of the responses is detected, without fail, at the reader/writer's side, in the case where other wireless IC communication devices include the wireless IC communication device that sends a response in a time slot specified by the number of time slots.

The response slot information may be a random number sequence generated by a predetermined wireless IC communication device. In such case, the response slot determination unit determines that a response should be sent in a time slot specified by the random number sequence. Thus, the collision of the responses is detected, without fail, at the reader/writer's side, in the case where other wireless IC communication devices include the predetermined wireless IC communication device.

In the case where the response slot information indicates that responses should be sent to part of the time slots, the response slot determination unit may determine that responses should be sent in more than two time slots. Namely, the number of time slots to which a response should be sent may be an appropriate number according to the case of application.

In the case where the response slot information indicates that responses should be sent to part of the time slots, the response slot determination unit may determine that responses should be sent in more than two time slots whose numbers are in sequence. The advantage is that it is easier to manufacture the wireless IC communication device that sends a response in the slots whose numbers are in sequence than the wireless IC communication device that sends a response in the slots whose numbers are not in sequence.

The wireless IC communication device may further include a response slot information obtainment unit that obtains the response slot information, wherein the response slot information storage unit may store the response slot information obtained by the response slot information obtainment unit. This it is possible to obtain, if necessary, the response slot information from an external device.

The wireless IC communication device may further include a timer that validates a function of the response slot determination unit only during a predetermined period of time. Thus, it is possible to sufficiently bring out the original merits of the anti-collision function since invalidation of the anti-collision function can be reduced to a minimum level of requirement.

Note that the present invention can be realized as a method that includes, as steps, such characteristic units included in the wireless IC communication device, or as a program that causes a computer to execute these steps, and even as a storage medium, such as a CD-ROM, into which the program is stored, or as an integrated circuit. The program can be distributed via a transmission medium such as a communication network and the like.

### FURTHER INFORMATION ABOUT TECHNICAL BACKGROUND TO THIS APPLICATION

The disclosure of Japanese Patent Application No. 2004-154142 filed on May 25, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1A shows how to use general wireless IC tags;

FIG. 1B shows another way to use general wireless IC tags;

FIG. 2 is a timing chart showing a general anti-collision function;

FIG. 3 is a flowchart showing an operation performed by a general wireless IC communication device for sending an initial response;

FIG. 4 shows a hardware configuration of a general wireless IC tag;

FIG. 5 shows a hardware configuration of a general contactless IC card;

FIG. 6A shows a software configuration of a wireless IC communication device of the present invention;

FIG. 6B shows a software configuration of a wireless IC communication device equipped with a response slot information obtainment unit, according to the present invention;

FIG. 7 is a flowchart showing an operation performed by the wireless IC communication device of the present invention for sending initial responses;

FIG. 8 is a flowchart showing an operation performed by a general reader/writer;

FIG. 9 is a time chart used for invalidating anti-collision function, according to a first embodiment of the present invention;

FIG. 10 shows an example of response slot information according to the present invention;

FIG. 11 is a time chart used for invalidating anti-collision function, according to a second embodiment of the present invention;

FIG. 12 is another time chart used for invalidating anti-collision function, according to the second embodiment;

FIG. 13 is a time chart used for invalidating anti-collision function, according to a third embodiment of the present invention;

FIG. 14 shows how to use a wireless IC tag according to the present invention;

FIG. 15 shows how to use a contactless IC card according to the present invention;

FIG. 16 is a software configuration of a wireless IC communication device according to a sixth embodiment of the present invention; and

FIG. 17 shows an example of the case of incorporating, into an integrated circuit, characteristic units of the wireless IC communication device according to the first through third embodiments.

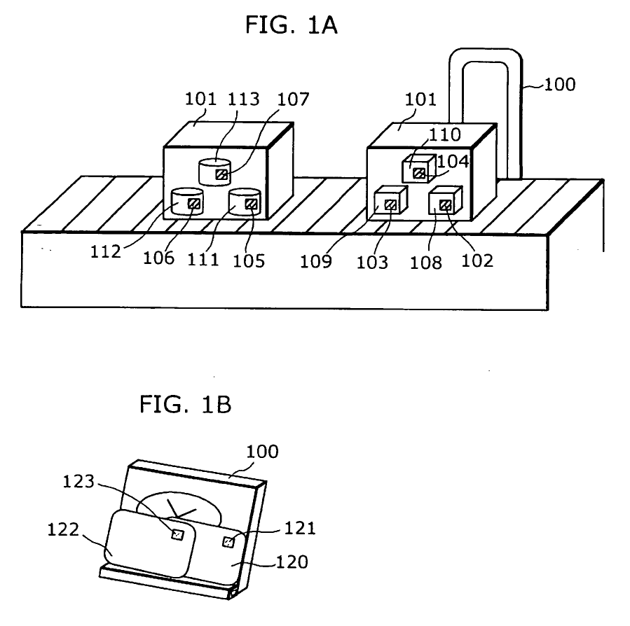

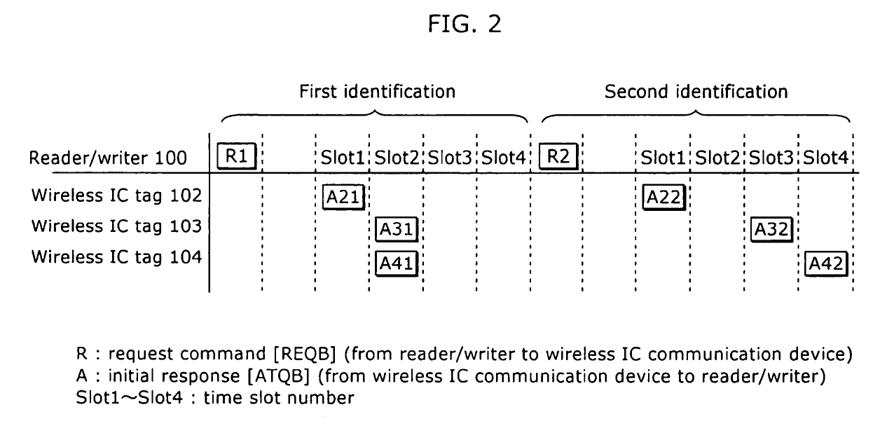

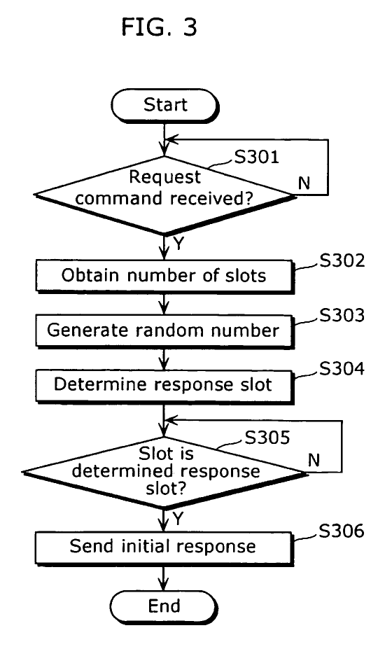

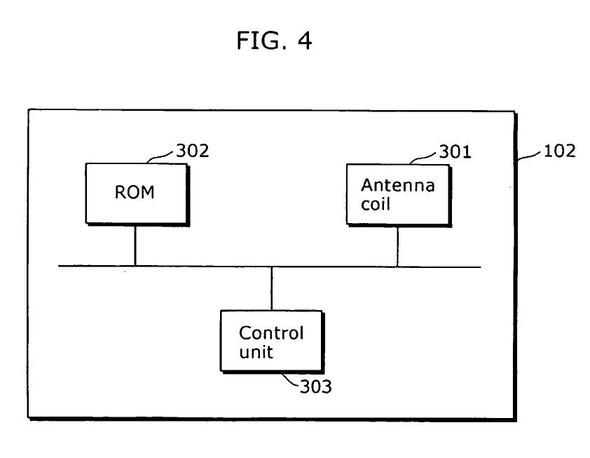

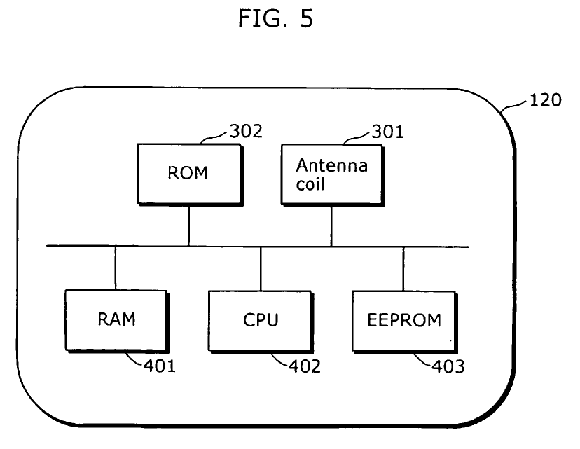

### BEST MODE FOR CARRYING OUT THE INVENTION

The following describes the embodiments of the present invention with reference to the drawings.

### First Embodiment

A hardware configuration of a wireless IC communication device according to the present invention is as same as that of a general one. The detailed description of the device is therefore not repeated here.

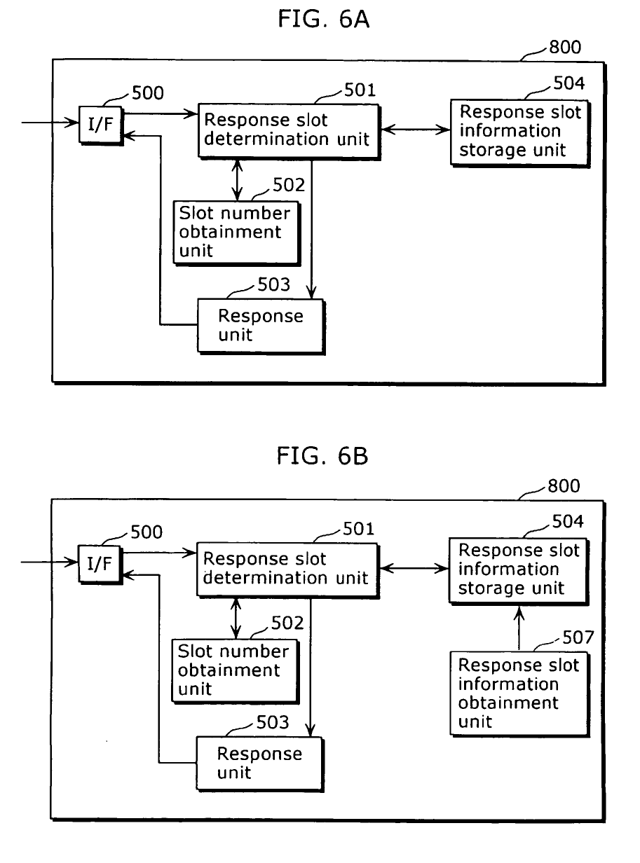

A software configuration of the wireless IC communication device according to the present invention will be described. FIG. 6A is the software configuration of the wireless IC communication device according to the present invention. A wireless IC communication device 800 includes a communication unit 500, a slot number obtainment unit 502, a response slot determination unit 501, a response unit 503, and a response slot information storage unit 504.

The communication unit 500 sends and receives data to and from the reader/writer 100. The slot number obtainment unit 502 obtains the number of time slots which is included in a request command sent from the reader/writer 100. The response slot information storage unit 504 stores, response slot information indicating a condition for sending an initial response to the reader/writer 100 in the same time slot as the time slot in which at least one of other wireless IC communication devices sends an initial response. The response slot determination unit 501 determines a time slot in which an initial response should be sent to the reader/writer 100, based on the number of time slots and the response slot information. The response unit 503 sends an initial response to the reader/writer 100 in the determined time slot.

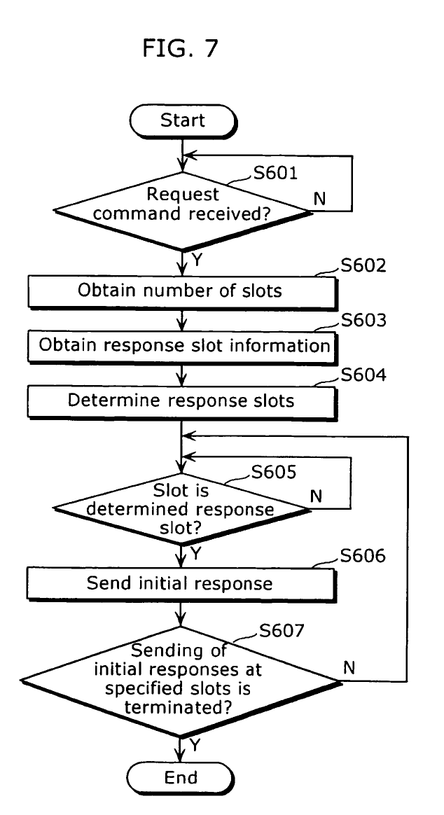

FIG. 7 is a flowchart showing an operation performed by the wireless IC communication device 800 of the present invention for sending initial responses. The following describes a structure of the wireless IC communication device 800 and its operation, with reference to FIG. 7.

Being located in a communication area of the reader/writer 100, the wireless IC communication device 800 is firstly provided with power due to induced electromotive force, and waits until a request command is sent (N in Step S601).

Having received a request command (Y in Step S601), the slot number obtainment unit 502 obtains the number of slots which is included in the request command (Step S602), and notifies the response slot determination unit 501 of the obtained number.

Then, the response slot determination unit 501 obtains response slot information from the response slot information storage unit 504 (Step S603), and determines a response slot based on the response slot information and the number of slots that is notified by the slot number obtainment unit 502 (Step S604).

Here, the response slot information according to the first embodiment is information indicating that initial responses should be sent in all the slots (the detail will be mentioned later). It is assumed that the number of slots that is notified by the slot number obtainment unit 502 is “6”. The response slot determination unit 501 therefore determines that initial responses should be sent to all the slots from Slot1 to Slot6, and notifies the response unit 503 of the determination.

Then, the response unit 503 waits until the slot, in which an initial response should be sent to the reader/writer 100, comes (N in Step S605). Here, being notified that initial responses should be sent in all the slots from Slot1 to Slot6, the response unit 503 sends an initial response firstly in Slot1 (Step S606). After that, initial responses are sent respectively in Slot2 through Slot5, and after an initial response is sent in the last Slot6, the processing of sending initial responses is completed.

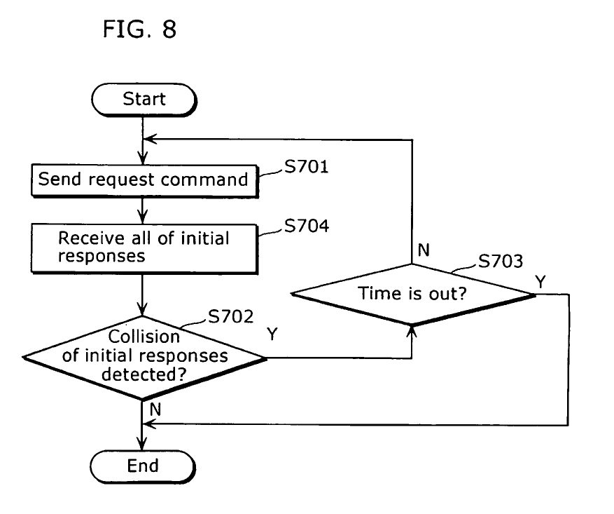

FIG. 8 is a flowchart showing an operation performed by a general reader/writer. The following describes, with reference to FIG. 8, an operation of the reader/writer 100 that communicates with plural wireless IC communication devices.

The reader/writer 100 sends a request command (Step S701) and waits for initial responses to be sent. In some cases, a collision of the initial responses occurs (Y in Step S702) as a result of the transmission of the initial responses from all the wireless IC communication devices (Step S704).

In the case where a predetermined time has not elapsed (N in Step S703), the reader/writer 100 again sends a request command (Step S701). In the case where a predetermined time has elapsed (Y in Step S703), the time is out so that the reader/writer 100 terminates the communication.

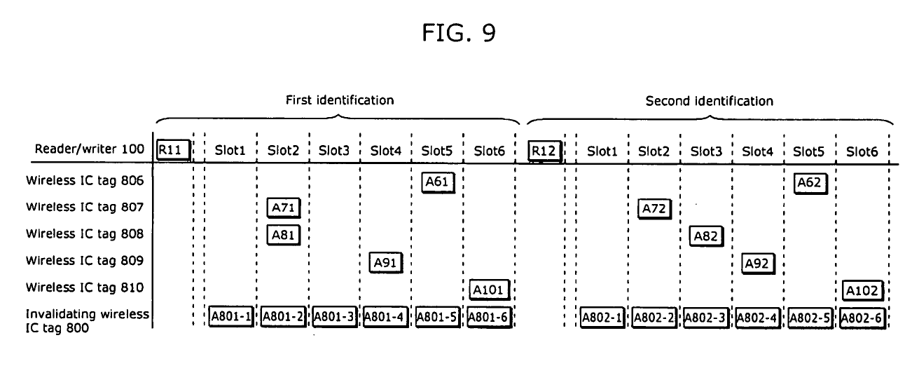

FIG. 9 is a time chart used for invalidating anti-collision function, according to the first embodiment. The following describes, with reference to FIG. 9, an operation performed by the wireless IC tag according to the first embodiment.

Note that it is presupposed here that the wireless IC tag 800 is the only tag that is the present invention while other wireless IC tags 806 through 810 are general wireless IC tags. The wireless IC tag of the present invention is a tag for invalidating anti-collision function. This is why the wireless IC tag 800 is also referred to as “invalidating wireless IC tag 800” in the description below.

At first, the reader/writer 100 sends a request command R11 for identifying the wireless IC tags for the first time. Each of the wireless IC tags 806 through 810 and 800 receives the request command R11, and obtains the number of slots which is included in the request command R11. Here, the number of slots is assumed to be “6”.

The general wireless IC tags 806 to 810 respectively send an initial response in any one of Slot1 to Slot6. In other words, the wireless IC tag 806 sends an initial response A61 in Slot5 and the wireless IC tag 807 sends an initial response A71 in Slot2 while the wireless IC tag 808 sends an initial response A81 in Slot2, the wireless IC tag 809 sends an initial response A91 in Slot4 and the wireless IC tag 810 sends an initial response A101 in Slot6.

The invalidating wireless IC tag 800, in contrast, sends initial responses A801-1 to A801-6 in all the slots from Slot1 to Slot6. As a result, the reader/writer 100 detects a collision of the initial responses, and sends a request command R12 for identifying the wireless IC tags for the second time.

The general wireless IC tags 806 to 810 respectively send an initial response in any one of Slot1 to Slot6. That is to say, the wireless IC tag 806 sends an initial response A62 in Slot5, the wireless IC tag 807 sends an initial response A72 in Slot2 while the wireless IC tag 808 sends an initial response A82 in Slot3, the wireless IC tag 809 sends an initial response A92 in Slot4 and the wireless IC tag 810 sends an initial response A102 in Slot6.

Focusing only on these wireless IC tags 806 through 810, no collisions occur between the initial responses. However, the reader/writer 100 detects again a collision of the initial responses after the invalidating wireless IC tag 800 has sent initial responses A802-1 to A802-6 in all the slots from Slot1 to Slot6, as in the case of the first identification.

The reader/writer 100 continues to detect a collision of the initial responses in the same way, until no such collision is detected within a predetermined time. As a result of not detecting such collision, the reader/writer 100 cannot identify the wireless IC tags 806 through 810 and 800. Consequently, processing (e.g. data reading) that follows such identification can not be performed.

As described above, the invalidating wireless IC tag according to the first embodiment sends initial responses in all the slots specified by the reader/writer. With such operation, the information in the wireless IC tag cannot be read out without owner's permission. This assures safety in the owner's daily life so that the owner does not need to worry about his/her privacy.

Note here that a wireless IC tag is taken as an example in the description, however, the present invention is not limited to this. That is to say, the present invention can be applied to a different type of wireless IC communication device such as a contactless IC card.

In the case of applying the present invention to a contactless IC card, it is possible to download a desired program into such contactless IC card. In other words, the anti-collision invalidating function according to the present invention can be installed in the contactless IC card, if necessary.

### Second Embodiment

In the first embodiment, it is described that the wireless IC communication device sends initial responses in all the slots specified by the reader/writer. The present invention, however, is not limited to this. In other words, the wireless IC communication device may send initial responses in a part of the slots specified by the reader/writer.

The following description focuses mainly on the difference between the second and first embodiments. The basic structure of the present embodiment is as same as that of the first embodiment. The contents of response slot information, however, differ from those described in the first embodiment. That is to say, the response slot information according to the first embodiment is information indicating that initial responses should be sent in all the slots. In contrast, the response slot-information according to the second embodiment is information indicating that initial responses should be sent in a part of the slots.

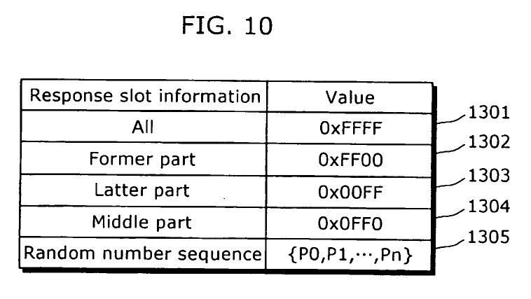

FIG. 10 shows an example of the response slot information according to the present invention. Firstly, response slot information 1301 is an example of the response slot information according to the first embodiment. Namely, the response slot information 1301 (value: 0xFFFF) is information indicating that initial responses should be sent in all the slots (e.g. from Slot1 to Slot6).

The response slot information 1302 to 1304 respectively show an example of the response slot information according to the second embodiment. Namely, the response slot information 1302 (value: 0xFF00) is information indicating that initial responses should be sent in a former part of the slots (e.g. from Slot1 to Slot3). The response slot information 1303 (value: 0x00FF) is information indicating that initial responses should be sent in a latter part of the slots (e.g. from Slot4 to Slot6). The response slot information 1304 (value: 0x0FF0) is information indicating that initial responses should be sent in a middle part of the slots (e.g. Slot3 and Slot4).

The operation performed by the wireless IC communication device according to the second embodiment for sending initial responses is as same as the one described in the first embodiment (see reference to FIG. 7), except that the slots in which initial responses should be sent are different. Also, the operation performed by the reader/writer is as same as the one described in the first embodiment (see reference to FIG. 8).

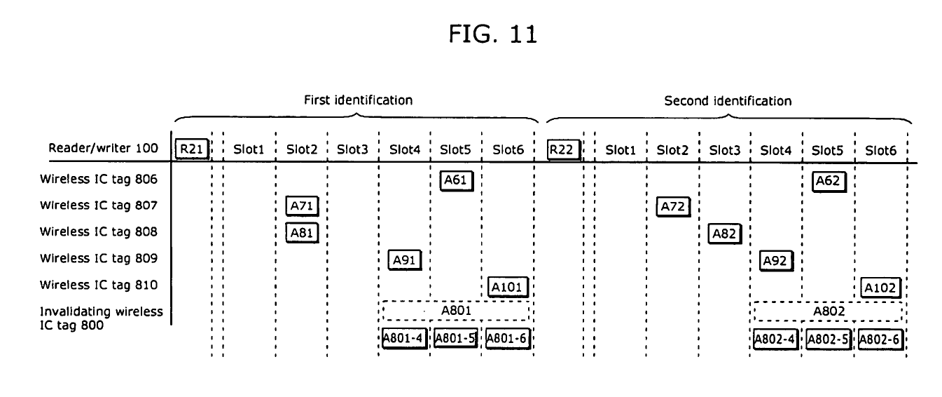

FIG. 11 is a time chart used for invalidating anti-collision function, according to the second embodiment of the present invention. The following describes, with reference to FIG. 11, the operation performed by the wireless IC tag according to the second embodiment.

Note also that it is presupposed in the description that the wireless IC tag 800 is the only tag that is the present invention while other wireless IC tags 806 to 810 are general wireless IC tags. It is also presupposed that the response slot information 1303 (value: 0x00FF) indicating that initial responses should be sent at a latter part of the slots is used as response slot information.

The reader/writer 100 sends a request command R21 for identifying the wireless IC tags for the first time. Each of the wireless IC tags 806 through 810 and 800 receives the request command R21, and obtains the number of slots which is included in the request command R21. Here, the number of slots is also assumed to be “6”.

The general wireless IC tags 806 to 810 respectively send in any one of Slot1 to Slot6. That is to say that the wireless IC tag 806 sends an initial response A61 in Slot5 and the wireless IC tag 807 sends an initial response A71 in Slot2, while the wireless IC tag 808 sends an initial response A81 in Slot2, the wireless IC tag 809 sends an initial response A91 in Slot4, and the wireless IC tag 810 sends an initial response A101 in Slot6.

In contrast, the invalidating wireless IC tag 800 sends initial responses in a part of the slots. Here, the response slot information indicates “0x00FF” so that the invalidating wireless IC tag 800 sends initial responses A801 (A801-4 to A801-6) in Slot4 to Slot6. As a result, the reader/writer 100 detects a collision of the initial responses, and sends a request command R22 for identifying the wireless IC tags for the second time.

The general wireless IC tags 806 to 810 respectively send initial responses in any one of Slot1 to Slot6. That is to say that the wireless IC tag 806 sends an initial response A62 in Slot5 and the wireless IC tag 807 sends an initial response A72 in Slot2, while the wireless IC tag 808 sends an initial response A82 in Slot3, the wireless IC tag 809 sends an initial response A92 in Slot4 and the wireless IC tag 810 sends an initial response A102 in Slot6.

Focusing only on these wireless IC tags 806 through 810, no collisions occur between the initial responses. However, the reader/writer 100 detects again a collision of the initial responses after the invalidating wireless IC tag 800 of the present invention has sent initial responses A802-4 to A802-6 in Slot4 to Slot6, as in the case of the first identification.

The reader/writer 100 continues to detect a collision of the initial responses in the same way until no such collision is detected within a predetermined time. As a result of not detecting such collision, the reader/writer 100 can identify neither the wireless IC tags 806 through 810 nor 800. Consequently, processing (e.g. data reading) that follows such identification cannot be performed.

As described above, the invalidating wireless IC tags according to the second embodiment respectively send an initial response in a part of the slots specified by the reader/writer. With such operation, it is possible to provide a wireless IC tag that offers high convenience to those who own the items as well as those who inspect the goods.

In the present embodiment, the wireless IC tag that sends responses only in the slots within a specified range, in stead of the general wireless IC tags, are used for the wireless IC tags 806 through 810. In order to thus send responses in the slots within a specified range, the response slot information 1302 or the like may be previously stored in the respective wireless IC tags 806 to 810, and a random number may be generated, for each wireless IC tag, within the range indicated in the response slot information. The following describes in detail such embodiment.

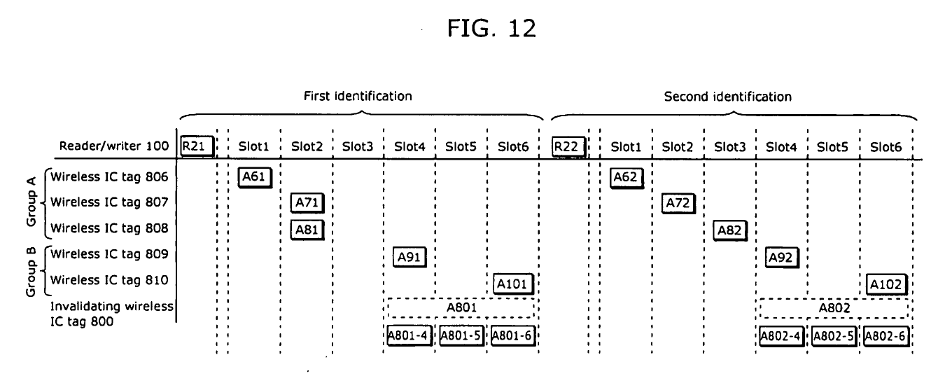

FIG. 12 is another time chart used for invalidating anti-collision function, according to the second embodiment. Here, it is presupposed that the wireless IC tags 806 to 808 are the wireless IC tags that send responses only in the former part of the slots (hereinafter to be referred to as “the wireless IC tags that belong to Group A”). The wireless IC tags 809 and 810 are the wireless IC tags that send responses only in the latter part of the slots (hereinafter to be referred to as “the wireless IC tags that belong to Group B”). The wireless IC tag 800 is an invalidating wireless IC tag of the present invention, and is used for invalidating the anti-collision function installed in each of the wireless IC tags that belong to Group B. In the description, it is assumed that the response slot information 1303 held by the wireless IC tag 800 is information (value: 0x00FF) indicating that initial responses should be sent in the latter slots.

The reader/writer 100 firstly sends a request command R21 for identifying the wireless IC tags for the first time. The request command R21 is received by the wireless IC tags 806 through 810 and 800. The wireless IC tags 806 through 810 and 800 obtain the number of slots which is included in the request command R21. It is also assumed here that the number of slots is “6”.

The wireless IC tags 806 to 808 that belong to Group A send initial responses in any one of Slot1 to Slot3. That is to say that the wireless IC tag 806 sends an initial response A61 in Slot1, the wireless IC tag 807 sends an initial response A71 in Slot2, and the wireless IC tag 808 sends an initial response A81 in Slot2.

The wireless IC tags 809 and 810 that belong to Group B send initial responses in any one of Slot 4 to Slot6. That is to say that the wireless IC tag 809 sends an initial response A91 in Slot4 while the wireless IC tag 810 sends an initial response A101 in Slot6.

The invalidating wireless IC tag 800 of the present invention, in contrast, invalidates the anti-collision function installed in the respective wireless IC tags 809 and 810 that belong to Group B. In this case, the response slot information indicates “0x00FF” so that the invalidating wireless IC tag 800 sends initial responses A801 (A801-4 to A801-6) in Slot4 to Slot6. As a result, the reader/writer 100 detects a collision of the initial responses, and sends a request command R22 for identifying the wireless IC tags for the second time.

Here, the wireless IC tags 806 to 808 that belong to Group A send initial responses in any one of Slot1 to Slot3. That is to say that the wireless IC tag 806 sends an initial response A62 in Slot1, the wireless IC tag 807 sends an initial response A72 in Slot2, and the wireless IC tag 808 sends an initial response A82 in Slot3.

The wireless IC tags 809 and 810 that belong to Group B send initial responses in any one of Slot4 to Slot6. That is to say that the wireless IC tags 809 sends an initial response A92 in Slot4 while the wireless IC tag 810 sends an initial response A102 in Slot6.

Focusing only on the wireless IC tags 806 through 810, no collisions occur between the initial responses. However, the reader/writer 100 detects again a collision of the initial responses after the invalidating wireless IC tag 800 of the present invention has sent initial responses A802-4 to A802-6 in Slot4 to Slot6.

The reader/writer 100 continues to detect a collision of the initial responses in the same way until no such collision is detected within a predetermined period of time. As a result of not detecting such collision, the reader/writer 100 can identify neither the wireless IC tags 806 through 810 nor 800. Consequently, processing (e.g. data reading) that follows such identification cannot be performed.

As described above, the wireless IC tags to be invalidated may be divided into plural groups by using the invalidating wireless IC tag of the present invention together with the wireless IC tags that send responses only in the slots within a specified range. Thus, it is possible to invalidate anti-collision function for only the wireless IC tags that belong to a specified group.

For example, the wireless IC tags that belong to Group A may be attached to daily goods while the wireless IC tags that belong to Group B may be attached to cosmetic items. Also, a wireless IC tag for invalidating anti-collision function installed in each of the wireless IC tags that belong to Group B may be attached to a bag that contains both the daily goods and the cosmetic items. In this way, the anti-collision function is invalidated as long as the cosmetic items are contained in the bag. This surely means that the anti-collision function works during the time when the cosmetic items are not in the bag.

It should be noted that the second embodiment describes that the wireless IC tags send initial responses in a part of the slots specified by the reader/writer. The number provided for “a part of the slots”, however, is not limited to the number indicated in the embodiment. An appropriate number may be used depending on the case of application.

It is preferable that “a part of the slots” here are the slots whose numbers are in sequence such as Slot1 through Slot3 or Slot4 through Slot6. This is because the wireless IC tag that sends responses at one of the slots whose numbers are in sequence is easy to manufacture than the wireless IC tag that sends responses at one of the slots whose numbers are not in sequence.

The present embodiment describes that in the case where the number of slots is “6” and the response slot information indicates “0x00FF”, initial responses are to be sent in Slot 4 to Slot 6, however, the present invention is not limited to this case. For example, “0x00FF” may be regarded as a value (i.e. 255) so that the wireless IC tags may send initial responses after Slot255. In such case, when the number of slots specified by the reader/writer 100 is less than 255, the reader/writer 100 identifies the wireless IC tags 806 through 810 and 800.

### Third Embodiment

In the second embodiment, it is described that the wireless IC tag communication device sends initial responses in a part of the slots specified by the reader/writer. The present invention, however, is not limited to this. That is to say that the wireless IC communication device of the present invention may send an initial response in the same slot as the slot in which at least one of other wireless IC communication devices sends an initial response.

The following description mainly focuses on the difference between the third and first embodiments. The basic structure of the present embodiment is as same as that of the first embodiment. The contents of response slot information, however, differs from the one described in the first embodiment. That is to say, the response slot information according to the first embodiment is information indicating that initial responses should be sent in all the slots. In contrast, the response slot information according to the third embodiment is a random number sequence generated by a predetermined wireless IC communication device.

As is already mentioned above, a general wireless IC communication device generates a random number, and determines a response slot based on the random number. In the third embodiment, as shown in FIG. 10, a random number sequence {P0, P1, . . . Pn} generated by a predetermined wireless IC communication device is set as the response slot information 1305. “P0”, “P1” and “Pn” here are, for instance, positive integer numbers, and the notation should not be limited particularly to this.

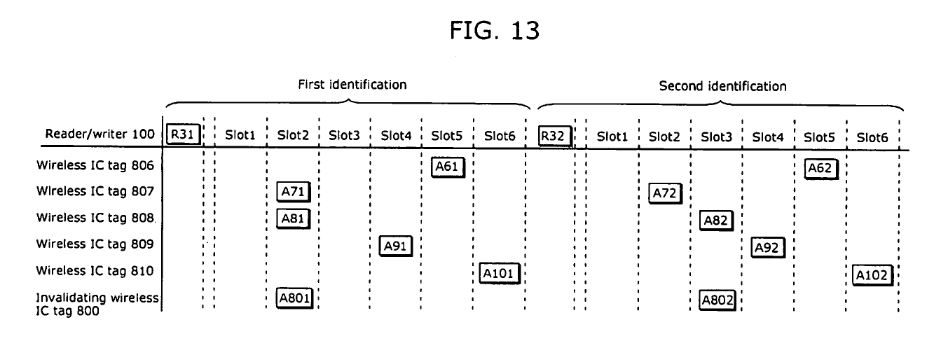

FIG. 13 is a time chart used for invalidating anti-collision function, according to the third embodiment. The following describes, with reference to FIG. 13, an operation performed by the wireless IC tag according to the third embodiment.

Note that it is also presupposed here that the wireless IC tag 800 is the only tag that is the present invention while other wireless IC tags 806 to 810 are general wireless IC tags. It is also assumed that the response slot information 1305 is a random number sequence generated by the wireless IC tag 808.

Firstly, the reader/writer 100 sends a request command R31 for identifying the wireless IC tags for the first time. Each of the wireless IC tags 806 through 810 and 800 receives the request command R31 and obtains the number of slots which is included in the request command R31. Here, the number of slots is assumed to be “6”.

The general wireless IC tags 806 to 810 respectively send an initial response in any of Slot1 to Slot6. In other words, the wireless IC tag 806 sends an initial response A61 in Slot5 and the wireless IC tag 807 sends an initial response A71 in Slot2, while the wireless IC tag 808 sends an initial response A81 in Slot2, the wireless IC tag 809 sends an initial response A91 in Slot4 and the wireless IC tag 810 sends an initial response A101 in Slot6.

In contrast, the invalidating wireless IC tag 800 sends an initial response in the same slot as the slot in which the wireless IC tag 808 sends an initial response. That is to say that the response slot information 1305 held by the invalidating wireless IC tag 800 is a random number sequence generated by the wireless IC tag 808. Here, the invalidating wireless IC tag 800 sends an initial response A801 in a slot (i.e. Slot2) that corresponds to the number indicated in a position “P0” at the head of the sequence. Thus, the reader/writer 100 detects a collision of the initial responses, and sends a request command R32 for identifying the wireless IC tags for the second time.

The general wireless IC tags 806 to 810 respectively send an initial response in any of Slot1 to Slot6. That is to say that the wireless IC tag 806 sends an initial response A62 in Slot5 and the wireless IC tag 807 sends an initial response A72 in Slot2, while the wireless IC tag 808 sends an initial response A82 in Slot3, the wireless IC tag 809 sends an initial response A92 in Slot4 and the wireless IC tag 810 sends an initial response A102 in Slot6.

Focusing only on the wireless IC tags 806 through 810, no collisions occur between the initial responses. The invalidating wireless IC tag 800 of the present invention sends, as in the case of the first identification, an initial response in the same slot as the slot in which the wireless IC tag 808 sends an initial response. Here, the initial response is sent in the slot (i.e. Slot3) that corresponds to the number indicated in a position “P2” that is secondly indicated in the sequence. As a result, the reader/writer 100 detects again a collision of the initial responses.

The reader/writer 100 continues to detect a collision of the initial responses in the same way until no such collision is detected within a predetermined time. As a result of not detecting such collision, the reader/writer 100 can identify neither the wireless IC tags 806 through 810 nor 800. Consequently, processing (e.g. data reading) that follows such identification cannot be performed.

As described above, the invalidating wireless IC tag according to the third embodiment sends an initial response in the same slot as the slot in which at least one of other wireless IC tags sends an initial response. With such operation, it is possible to realize a reproduction of the random number sequence generated by the wireless IC tag whose anti-collision function is to be invalidated. This also means that the wireless IC tag for invalidating anti-collision function can be easily manufactured.

Note that, in order to newly communicate with the reader/writer 100, the invalidating wireless IC tag 800 and the wireless IC tag 808 use a random number sequence {P0, P1, . . . Pn} sequentially from the number indicated in a position “P0” that is at the head of the sequence. This is because the invalidating wireless IC tag 800 cannot send an initial response in the same slot as the slot in which the wireless IC tag 808 sends an initial response, in the case where an initial position in the random number sequence changes.

### Fourth Embodiment

The following describes how to use the wireless IC communication device according to the present invention.

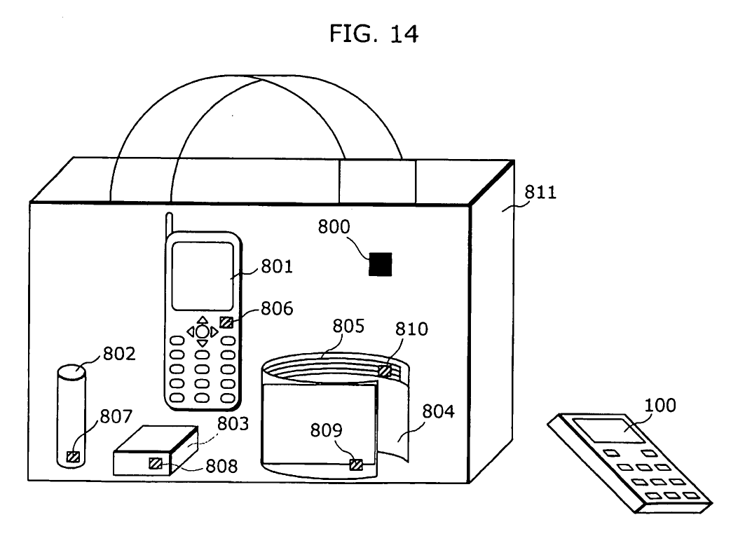

FIG. 14 shows how to use the wireless IC communication device according to the present invention. The invalidating wireless IC tag 800, an item-containing bag 811, items 801 through 805, the wireless IC tags 806 to 810, and the reader/writer 100 are included in the environment where the wireless IC communication device is used.

The invalidating wireless IC tag 800 is attached to the bag 811. The present invention is not limited to use the bag 811, and another container may be used instead. As for the items, a cell phone 801, a cosmetic item 802, a tobacco 803, a wallet 804 and money 805 are shown as the examples. The present invention is not limited to use such items, and any item may be used provided that a wireless IC tag is attached to it. Each of the wireless IC tags 806 through 810 is attached to each of the items so that the reader/writer 100 can read the respective wireless IC tags. Here, the portable reader/writer 100 is used as an example, but a fixed one may be used instead.

The invalidating wireless IC tag 800 invalidates anti-collision function under such circumstances. The reader/writer 100 therefore cannot identify each of the wireless IC tags 806 through 810 that is attached to each of the items contained in the bag 811. The owner of the items can live in safety without being concerned about his/her privacy, since the amount of money in the wallet 804 and the information stored in the cell phone 801 are well protected.

### Fifth Embodiment

The fourth embodiment shows an example of attaching the invalidating wireless IC tag 800 to the bag 811. The use of the wireless IC communication device of the present invention, however, is not limited to this. The fifth embodiment describes another example for the use of the wireless IC communication device according to the present invention.

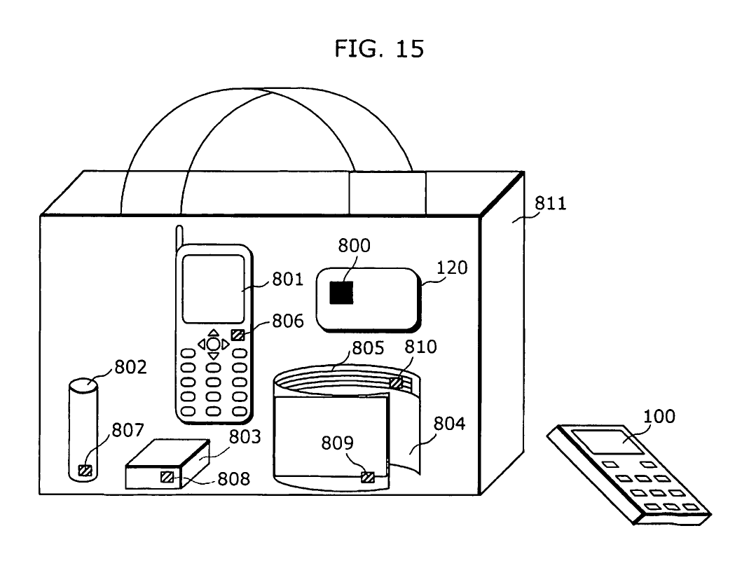

FIG. 15 shows how to use a contactless IC card according to the present invention. As shown in the diagram, it is possible to invalidate anti-collision function by placing the contactless IC card 120 in the bag 811.

In such case, the bag 811 may be replaced with another container. That is to say, the same effects as gained in the fourth embodiment can be obtained by placing the contactless IC card 120 in a container for carrying items. Thus, according to the fifth embodiment, the effects of the present invention can be gained by using any container of various types, without adhering to the use of the bag 811.

The invalidation of the anti-collision function may be similarly performed using a cell phone equipped with a contactless IC card function. In this case, the response slot information does not need to be stored in the response slot information storage unit 504 since the information can be downloaded from an external device. In other words, it is possible to utilize a communication unit included in a general cell phone, as a response slot information obtainment unit.

FIG. 6B shows a software configuration of the wireless IC communication device equipped with a response slot information obtainment unit. The response slot information obtainment unit 507 obtains response slot information from an external device, and allows the response slot information storage unit 504 to store the response slot information. The response slot information thus stored in the response slot information storage unit 504 is obtained by the response slot determination unit 501, as mentioned earlier (see reference to Step S603 in FIG. 7).

By thus using the cell phone equipped with a contactless IC card, the response slot information may be updated if necessary. Thus, even in the case where the information in the wireless IC tag that is attached to an item runs the risk of being leaked, a solution for preventing such leakage can be immediately taken.

### Sixth Embodiment

Through the first to fifth embodiments, the wireless IC communication device according to the present invention invalidates anti-collision function at all times. The present invention, however, is not limited to this, and the function to invalidate anti-collision function may operate during a predetermined period of time.

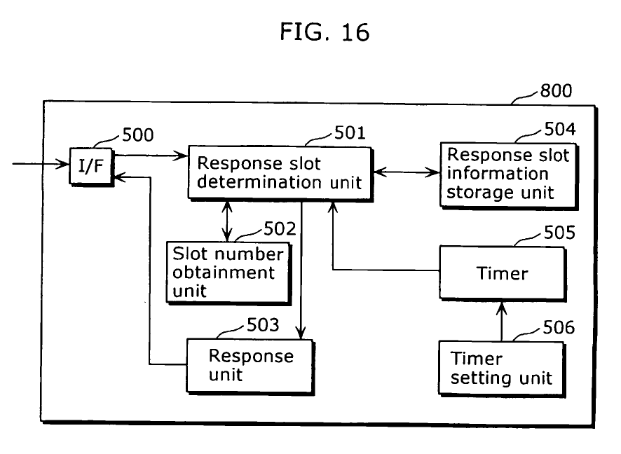

FIG. 16 is a software configuration of the wireless IC communication device according to the sixth embodiment. The wireless IC communication device 800 includes a timer 505 and a timer setting unit 506, in addition to the communication unit 500, the slot number obtainment unit 502, the response slot determination unit 501, the response unit 503 and the response slot information storage unit 504.

The timer 505 validates an anti-collision invalidating function (a function equipped in the response slot determination unit 501) installed in the wireless IC communication device only for a limited period of time during which the timer 505 is on. The timer setting unit 506 is a unit for setting the timer 505.

Thus, the response slot determination unit 501 functions during the period during which the timer 505 is on, serving as the response slot determination unit 501 described in each of the first to third embodiments. In this case, the wireless IC communication device operates as a device that invalidates anti-collision function.

For the period during which the timer 505 is turned off, the response slot determination unit 501 determines a response slot based on a random number that is generated, as in the conventional case. In this case, the wireless IC communication device operates as a general wireless IC communication device.

The following illustrates a case of applying the present invention to the wireless IC tag according to the sixth embodiment.

For example, when a person purchases in a certain shop, a staff in the shop turns on the timer of the wireless IC tag that is attached to a purchased item. In this way, the wireless IC tag functions as an invalidating wireless IC tag, for instance, for two hours. Thus, the information in the wireless IC tag cannot be leaked until the person reaches home after the shopping. The person can go home feeling safe, without that what the person has purchased is disclosed to the others. What is better, the timer of the wireless IC tag is turned off by the time when the person reaches home. The wireless IC tag whose timer is turned off functions as a general wireless IC tag, so that the purchaser of the item is not deprived of convenience.

Thus, according to the sixth embodiment, it is possible to invalidate anti-collision function only for a predetermined period of time. This means that the operation of the invalidation of anti-collision function can be limited to a minimum requirement, so that the merits as originally recognized as the anti-collision function can be sufficiently exercised.

Note that an anti-collision invalidating function may not be realized by the wireless IC tag that is already attached to an item at the time of purchasing the item. In other words, the same effects can be obtained even in the case of attaching the wireless IC tag equipped with anti-collision invalidating function to the item at a different time. The function of the invalidating wireless IC tag after the timer is turned off is not particularly limited to this case. Namely, after the timer is turned off, the anti-collision invalidating function may no longer function at all, or another particular function may be installed in the wireless IC tag.

The method of setting a timer is not limited to the above example. That is to say that the timer setting unit 506 may be included in an external device such as a reader/writer instead of the wireless IC communication device. In this way, the timer can be set in detail using a user interface equipped to the reader/writer.

The time to be set in a timer is not limited to the above example. For example, the timer of the wireless IC tag may be set to be ON from 8:00 to 9:00 AM. Thus, by previously attaching the wireless IC tag to the bag, it is possible to prevent leakage, during commutation to a workplace, of the information related to the items contained in the bag.

### Supplement 1 to First through Sixth Embodiments

As in the above description, the first through sixth embodiments are described. Each function of the response slot determination unit 501, the slot number obtainment unit 502 and the response unit 503 is typically realized through a computer program executed by a CPU. The program may be previously stored in a ROM in the wireless IC communication device, or may be stored in a non-volatile memory in the wireless IC communication device after the program is downloaded from an external resource. Note that in the case where the response slot information obtainment unit 507 is used, the function of the response slot information obtainment unit 507 is realized through a computer program executed by a CPU.

### Supplement 2 to First through Sixth Embodiments

In some cases, the functions of the units 501, 502 and 503 may be realized by an LSI that is an integrated circuit. Each of these functions may be incorporated into a chip or may be incorporated into a chip in units of groups.

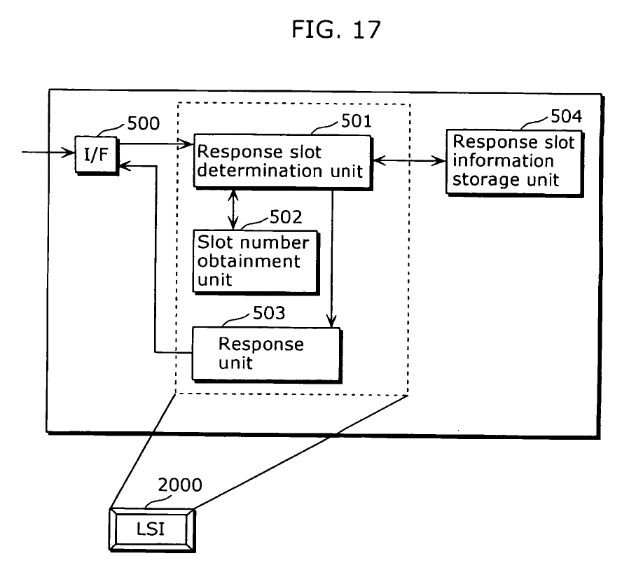

FIG. 17 shows an example of the case of incorporating, into an integrated circuit, the characteristic components included in the wireless IC communication device according to the first through third embodiments. An LSI 2000 is an example of such integrated circuit, and realizes the functions of the components included in the range indicated by a broken line in the diagram. The integrated circuit may be called “IC”, “system LSI”, “super LSI” and “ultra LSI” depending on the degree of integration. Note that in the case of using the response slot information obtainment unit 507, the function of the response slot information obtainment unit 507 can also be realized by the LSI 2000.

The integrated circuit is not limited to such LSI, and can be realized by a private circuit or a general processor. Instead, a Field Programmable Gate Array (FPGA) that can store programs after the manufacturing of LSI, or a configurable processor that can reconfigure connection and setting of a circuit cell included in an LSI may be used instead. With the arrival of new technique (e.g. bio-technology or organic chemistry technology) for the incorporation of components into an integrated chip, which replaces LSI due to the progress in semiconductor technique or to another technique deriving from it, the functions equipped in the wireless IC communication device may be surely integrated using such new technique.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The wireless IC communication device according to the present invention is effective in the prevention of leakage of information without permission of an owner who owns items to each of which the wireless IC communication device is respectively attached. Such wireless IC communication device of the present invention is applicable to a wireless IC tag and a contactless IC card.

1. A wireless integrated circuit (IC) communication device which communicates with a reader/writer, using a time slot method or a slot marker method, the device comprising:
a slot number obtainment unit operable to obtain a number of time slots which is included in a request command transmitted from the reader/writer;
a response slot information storage unit operable to store a response slot information indicating a condition for sending a response to the reader/writer in the same time slot as a time slot in which at least one of other wireless IC communication devices sends a response;
a response slot determination unit operable to determine a time slot in which the response should be sent to the reader/writer, based on the number of time slots and the response slot information; and
a response unit operable to send the response to the reader/writer in the determined time slot.

2. A wireless IC communication device according to claim 1,
wherein the response slot information indicates that responses should be sent in all of the time slots, and
the response slot determination unit is operable to determine that responses should be sent in all of the time slots specified by the number of time slots.

3. A wireless IC communication device according to claim 1,
wherein the response slot information indicates that responses should be sent in part of the time slots, and
the response slot determination unit is operable to determine that responses should be sent into part of the time slots specified by the number of time slots.

4. A wireless IC communication device according to claim 1,
wherein the response slot information is a random number sequence generated by a predetermined wireless IC communication device, and
the response slot determination unit is operable to determine that a response should be sent in a time slot specified by the random number sequence.

5. A wireless IC communication device according to claim 3,
wherein the response slot determination unit is operable to determine that responses should be sent in more than two time slots.

6. A wireless IC communication device according to claim 3,
wherein the response slot determination unit is operable to determine that responses should be sent in more than two time slots whose numbers are in sequence.

7. A wireless IC communication device according to claim 1, further comprising
a response slot information obtainment unit operable to obtain the response slot information,
wherein the response slot information storage unit is operable to store the response slot information obtained by the response slot information obtainment unit.

8. A wireless IC communication device according to claim 1, further comprising
a timer operable to validate a function of the response slot determination unit only during a predetermined period of time.

9. A response method used by a wireless integrated circuit (IC) communication device that communicates with a reader/writer, using a time slot method or a slot marker method, the response method comprising:
obtaining a number of time slots which is included in a request command transmitted from the reader/writer;
storing a response slot information indicating a condition for sending a response to the reader/writer in the same time slot as a time slot in which at least one of other wireless IC communication devices sends a response;
determining a time slot in which the response should be sent to the reader/writer, based on the number of time slots and the response slot information; and
sending the response to the reader/writer in the determined time slot.

10. A program for a communication between a wireless integrated circuit (IC) communication device and a reader/writer based on a time slot method or a slot marker method, the program causing a computer to execute:
obtaining a number of time slots which is included in a request command transmitted from the reader/writer;
storing a response slot information indicating a condition for sending a response to the reader/writer in the same time slot as a time slot in which at least one of other wireless IC communication devices sends a response;
determining a time slot in which the response should be sent to the reader/writer, based on the number of time slots and the response slot information; and
sending the response to the reader/writer in the determined time slot.

11. A computer-readable storage medium storing a program for a communication between a wireless integrated circuit (IC) communication device and a reader/writer based on a time slot method or a slot marker method,
wherein the program causes a computer to execute:
obtaining a number of time slots which is included in a request command transmitted from the reader/writer;
storing a response slot information indicating a condition for sending a response to the reader/writer in the same time slot as a time slot in which at least one of other wireless integrated circuit (IC) communication devices sends a response;
determining a time slot in which the response should be sent to the reader/writer, based on the number of time slots and the response slot information; and
sending the response to the reader/writer in the determined time slot.

12. An integrated circuit used by a wireless integrated circuit (IC) communication device that communicates with a reader/writer, using a time slot method or a slot marker method, the integrated circuit comprising:
a slot number obtainment unit operable to obtain a number of time slots which is included in a request command transmitted from the reader/writer;
a response slot determination unit operable to determine a time slot in which a response should be sent to the reader/writer, based on the number of time slots and a response slot information indicating a condition for sending the response to the reader/writer in the same time slot as a time slot in which at least one of other wireless IC communication devices sends a response; and
a response unit operable to send the response to the reader/writer in the determined time slot.
